(19) United States
(12) Patent Application Publication
(10) Pub. No.: US 2025/0356526 A1
(43) Pub. Date: Nov. 20, 2025

(54) IMAGE-BASED LOCALIZATION AND TRACKING USING THREE-DIMENSIONAL DATA

(71) Applicant: FARO Technologies, Inc., Lake Mary, FL (US)

(72) Inventors: Julian Becker, Korntal-Munchingen (DE); Oswin Horvath, Tamm (DE); Daniel Flohr, Stuttgart (DE); Martin Ossing, Tamm (DE)

(21) Appl. No.: 19/281,396

(22) Filed: Jul. 25, 2025

Related U.S. Application Data
(63) Continuation of application No. PCT/US2024/012864, filed on Jan. 25, 2024.
(60) Provisional application No. 63/481,646, filed on Jan. 26, 2023.

(51) Int. Cl. G06T 7/73; G06T 7/246; G06T 19/00; G06V 10/75

(52) U.S. Cl. CPC G06T 7/74; G06T 7/248; G06T 19/006; G06V 10/757; G06T 2207/10016; G06T 2207/10028; G06T 2210/56

(57) ABSTRACT

An example method collects first data comprising first surface points within an environment by a sensor associated with a processing system. The method further determines an estimated position of the processing system by analyzing the first data using a simultaneous localization and mapping algorithm and identifies a first set of surface features from the first data. The method further collects second data comprising second surface points within the environment by a three-dimensional (3D) coordinate measuring device associated with the processing system and identifies a second set of surface features from the second data. The method further matches the first set of surface features to the second set of surface features and refines the estimated position of the processing system to generate a refined position of the processing system. The method further displays an augmented reality representation of the second data based at least in part on the refined position.

### CROSS-REFERENCE TO RELATED APPLICATIONS

This application is a continuation of Internation Application No. PCT/US2024/012864, filed on Jan. 25, 2024, which claims the benefit of U.S. Provisional Patent Application No. 63/481,646, filed on Jan. 26, 2023, and entitled “IMAGE-BASED LOCALIZATION AND TRACKING USING THREE-DIMENSIONAL DATA,” the entire contents of both applications are incorporated by reference herein in their entirety.

### BACKGROUND

The subject matter disclosed herein relates to use of a three-dimensional (3D) laser scanner time-of-flight (TOF) coordinate measurement device. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They are also used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values include the distance and two angles, or are transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or another angle transducer). The beam steering mechanism also includes a second motor that steers the beam of light about a second axis by a second angle that is measured by a second angular encoder (or another angle transducer).

Many contemporary laser scanners include a camera mounted on the laser scanner for gathering camera digital images of the environment and for presenting the camera digital images to an operator of the laser scanner. By viewing the camera images, the operator of the scanner determines the field of view of the measured volume and adjust settings on the laser scanner to measure over a larger or smaller region of space. In addition, the camera digital images are transmitted to a processor to add color to the scanner image. To generate a color scanner image, at least three positional coordinates (such as x, y, z) and three color values (such as red, green, blue “RGB”) are collected for each data point.

One application where 3D scanners are used is to scan an environment.

Accordingly, while existing 3D scanners are suitable for their intended purposes, what is needed is a 3D scanner having certain features of embodiments described herein.

### BRIEF DESCRIPTION

According to an embodiment, a method performed by a processing system is provided. The method includes collecting first data comprising first surface points within an environment by a sensor associated with the processing system. The method further includes determining an estimated position of the processing system within the environment by analyzing the first data using a simultaneous localization and mapping algorithm. The method further includes identifying a first set of surface features within the environment from the first data. The method further includes collecting second data comprising second surface points within the environment by a three-dimensional (3D) coordinate measuring device associated with the processing system. The method further includes identifying a second set of surface features within the environment from the second data. The method further includes matching the first set of surface features to the second set of surface features. The method further includes refining the estimated position of the processing system to generate a refined position of the processing system based on the matching. The method further includes displaying, on a display of the processing system, an augmented reality representation of the second data based at least in part on the refined position.

According to another embodiment, a method performed by a processing system located within an environment is provided. The method includes measuring first three-dimensional (3D) data with a 3D coordinate measurement device during a first scan initiated by the processing system at a first location within the environment. The method further includes generating a first point cloud representing first surface points in the environment based at least in part on the first 3D data. The method further includes measuring second 3D data by the 3D coordinate measurement device during a second scan at a second location within the environment. The method further includes generating a second point cloud representing second surface points in the environment based at least in part on the second 3D data. The method further includes capturing video of the second surface points in the environment using a camera during at least one of the first scan and the second scan. The method further includes displaying, on a display of the processing system, an augmented reality representation of the environment including at least a portion of each of the first point cloud, the second point cloud and the video.

According to another embodiment, a method performed by a processing system is provided. The method includes generating a first point cloud of an environment based at least in part on first three-dimensional (3D) data captured during a first scan. The method further includes generating a second point cloud of the environment based at least in part on second 3D data captured during a second scan. The method further includes comparing the first point cloud and the second point cloud to identify a difference between the first point cloud and the second point cloud. The method further includes displaying, on a display, an augmented reality representation of at least the difference between the first point cloud and the second point cloud.

The above features and advantages, and other features and advantages, of the disclosure are readily apparent from the following detailed description when taken in connection with the accompanying drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5 is a schematic illustration of a processing system for image-based localization and tracking using laser scanner data according to one or more embodiments described herein;

FIG. 6 is a flow diagram of a method for image-based localization and tracking using laser scanner data according to one or more embodiments described herein;

FIG. 7 is a flow diagram of a method for image-based localization and tracking using laser scanner data according to one or more embodiments described herein;

FIG. 8 is a flow diagram of a method for image-based localization and tracking using laser scanner data according to one or more embodiments described herein;

FIG. 9 is a graphical representation of an interface that shows an augmented reality view of an environment according to one or more embodiments described herein;

FIG. 10A is a flow diagram of a method for registering a processing system and a laser scanner according to one or more embodiments described herein;

FIG. 10B depicts a flow diagram of a method for displaying an AR representation of a point cloud according to one or more embodiments described herein;

FIGS. 11A-11D depict screen shots of an augmented reality view according to one or more embodiments described herein;

FIG. 12A is a flow diagram of a method for comparing three-dimensional (3D) data using augmented reality according to one or more embodiments described herein;

FIG. 12B is a flow diagram of a method for comparing three-dimensional (3D) data using augmented reality according to one or more embodiments described herein;

FIGS. 13A-13F depict screen shots of an augmented reality view according to one or more embodiments described herein; and

FIG. 14 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for image-based localization and tracking using laser scanner data. Particularly, one or more embodiments described herein relate to image-based device localization and feature tracking that is enriched by three-dimensional (3D) measurement data (e.g., captured by a laser scanner) and object recognition. For example, a processing system (e.g., a smart phone, tablet computer, etc.) is located within an environment. The processing system controls a 3D scanner to cause the 3D scanner acquire 3D measurement data (or simply “3D data”) about an environment by performing a scan of the environment. It is useful to determine a location of the processing system and/or the 3D scanner within the environment. This is referred to as “localization.” It is also useful to track the movement of the processing system and/or the 3D scanner within the environment. This is referred to as “tracking.”

Conventional techniques for device localization within an environment are often insufficient. For example, such conventional techniques fail to adequately address the effects of drift in 3D measurement data over the course of the capturing process, provide uncertainty about the areas of the environment already captured, provide uncertainty about the sufficiency of 3D measurement data overlap, and the like.

To address these and other shortcomings of the prior art, one or more embodiments described herein provide for image-based localization and tracking using laser scanner data (e.g., 3D data obtained by a 3D scanner). The phrases “laser scanner data,” “3D data,” and “3D measurement data” are used interchangeably throughout the description. To provide image-based localization and tracking using laser scanner data, one or more embodiments uses one or multiple 3D measurement devices (e.g., laser scanners) to capture 3D measurement data about an environment and a processing system (e.g., a smart phone, tablet computer, etc.) that incorporates sensor fusion and/or simultaneous localization and mapping (SLAM) capabilities and sensor equipment (e.g., a camera, an inertial measurement unit, a compass, a light detecting and ranging sensor, etc.) to estimate a course surface map of the environment. The 3D measurement data is then used to refine the estimated course surface map of the environment, resulting in an improved approach to image-based localization and tracking.

The techniques described herein provide one or more advantages over the prior art. For example, one or more embodiments described herein remove drift by registering objects from 3D measurement data to objects from images/video. One or more embodiments described herein overlay 3D measurement data to images/video, where the overlay is used as a visual indication of scan-point coverage of a scanned environment. One or more embodiments described herein use colors for different scans where multiple scans are performed. One or more embodiments described herein fill gaps in the 3D measurement data using data captured by a 3D capturing device.

One or more embodiments described herein utilize simultaneous localization and mapping algorithms. SLAM is used to construct or update a map of an unknown environment while simultaneously tracking an agent's (such as a robot) location within it in various embodiments.

One or more embodiments described herein utilize augmented reality (AR). AR provides for enhancing the real physical world by delivering digital visual elements, sound, or other sensory stimuli (an “AR element”) via technology. For example, a user device (e.g., a smartphone, tablet computer, etc.) equipped with a camera and display is used to capture an image of an environment. In some cases, this includes using the camera to capture a live, real-time representation of an environment and displaying that representation on the display. An AR element is displayed on the display and is associated with an object/feature of the environment. For example, an AR element with information about how to operate a particular piece of equipment is associated with that piece of equipment and is digitally displayed on the display of the user device when the user device's camera captures the environment and displays it on the display. It is useful to know the location of the user device relative to the environment in order to accurately depict AR elements.

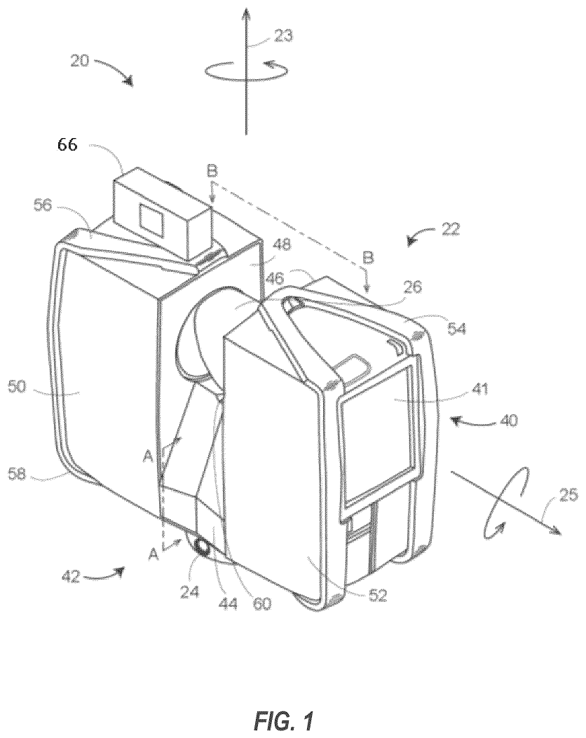

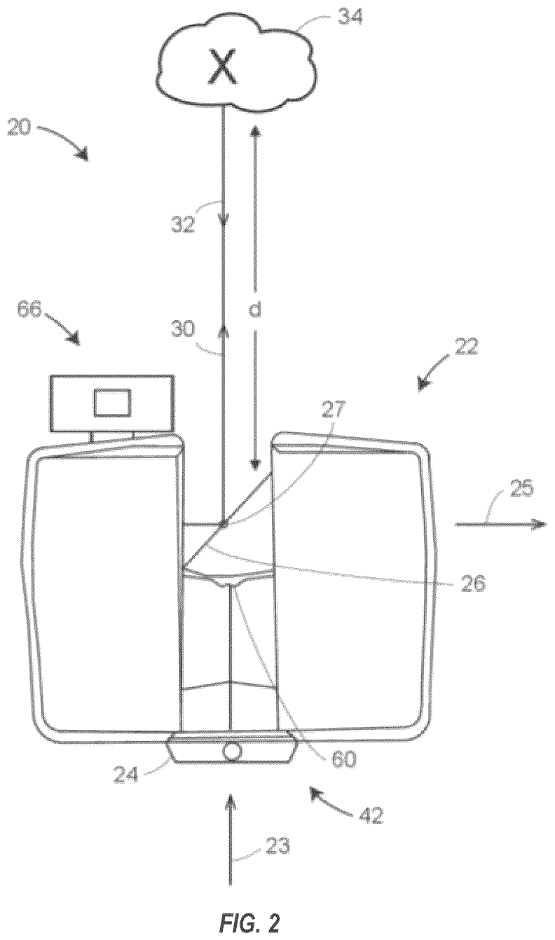

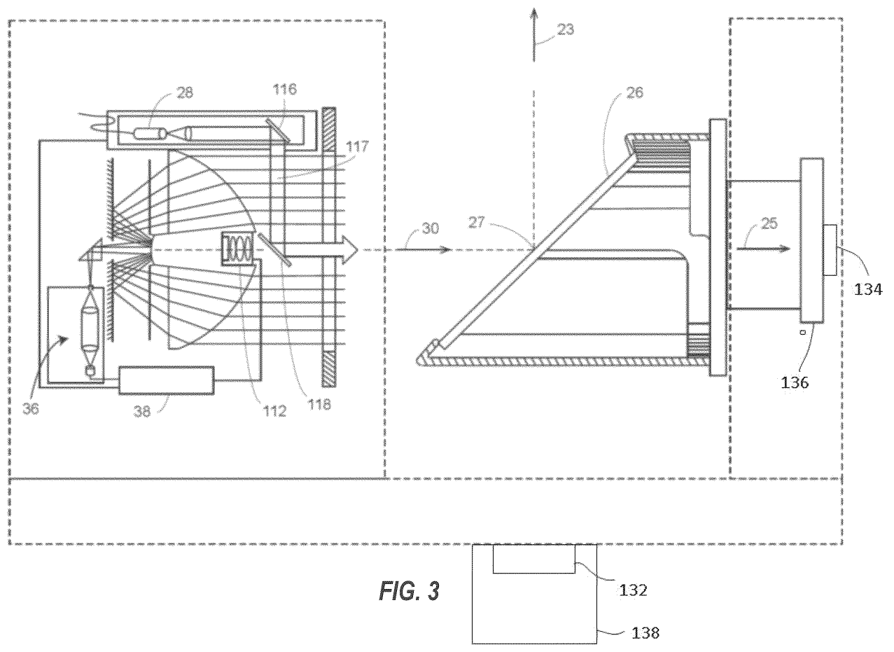

Referring now to FIGS. 1-3, a laser scanner 20 is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 is rotatable about a vertical axis 23. In one embodiment, the measuring head 22 includes a gimbal point 27 that is a center of rotation about the vertical axis 23 and a horizontal axis 25. The measuring head 22 has a rotary mirror 26, which is rotatable about the horizontal axis 25. The rotation about the vertical axis is about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis are substituted for the terms vertical axis and horizontal axis, respectively, in some instances. The term pan axis or standing axis is also used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. According to one or more embodiments, the laser beam has a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths are used in various embodiments. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 also collects gray-scale information related to the received optical power (equivalent to the term “brightness.”) The gray-scale value is determined at least in part, for example, by integration of the bandpass-filtered and amplified signal in the light receiver 36 over a measuring period attributed to the object point X.

The measuring head 22 includes a display device 40 integrated into the laser scanner 20 in various embodiments. The display device 40 includes a graphical touch screen 41 in various embodiments, as shown in FIG. 1, which allows the operator to set the parameters or initiate the operation of the laser scanner 20. For example, the screen 41 has a user interface that allows the operator to provide measurement instructions to the device, and the screen also displays measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 are coupled to the traverse 42, the walls 46, 48 and the shells 50, 54 at multiple locations in various embodiments.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d depends on signal strength, which is measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 is used to correct distance measurements for other measured points in various embodiments, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 is a device that captures and measures a parameter associated with the scanned area or the scanned object and provides a signal representing the measured quantities over an image acquisition area. According to one or more embodiments, the auxiliary image acquisition device 66 is, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and has the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 is a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view is easily obtained by simply adjusting the steering mechanisms of the scanner—for example, by adjusting the azimuth angle about the axis 23 and by steering the mirror 26 about the axis 25.

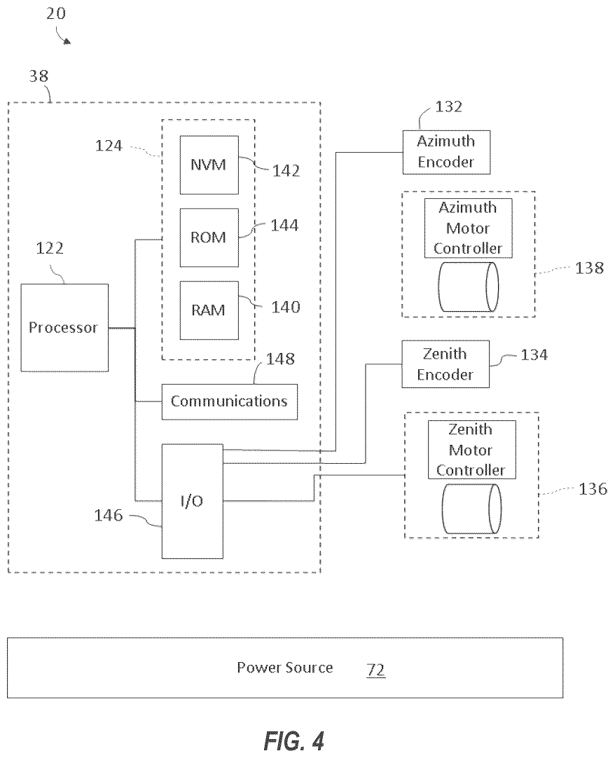

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. According to various embodiments, the processors are microprocessors, field programmable gate arrays (FPGAs), digital signal processors (DSPs), and/or generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 is displayed on a user interface 40 coupled to controller 38. The user interface 40 is one or more LEDs (light-emitting diodes) 82, an LCD (liquid-crystal diode) display, a CRT (cathode ray tube) display, a touch-screen display or the like. A keypad is also coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 is also coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. According to various embodiments, additional systems 20 are connected to LAN with the controllers 38 in each of these systems 20 being configured to send and receive data to and from remote computers and other systems 20. The LAN is connected to the Internet according to various embodiments. This connection allows controller 38 to communicate with one or more remote computers connected to the Internet.

The processors 122 are coupled to memory 124. The memory 124 includes at least one of a random access memory (RAM) device 140, a non-volatile memory (NVM) device 142, and a read-only memory (ROM) device 144. In addition, the processors 122 are connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software is encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

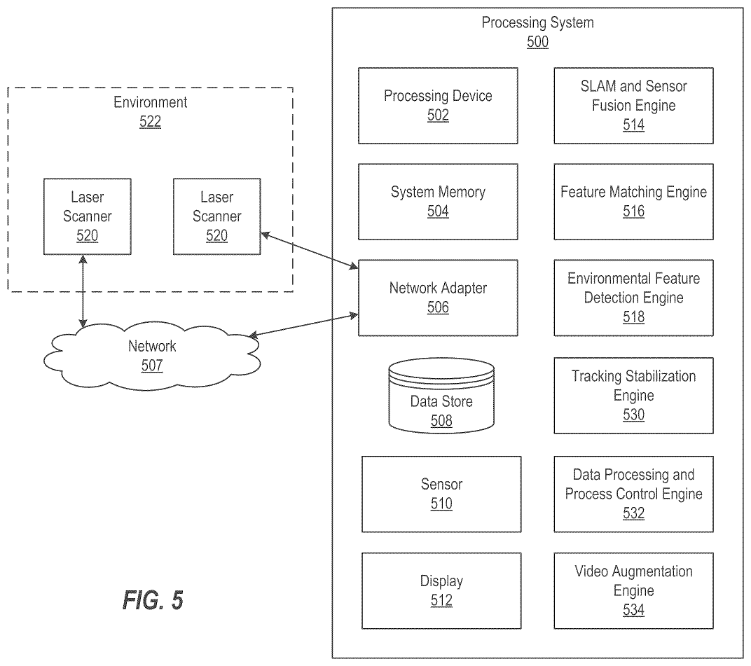

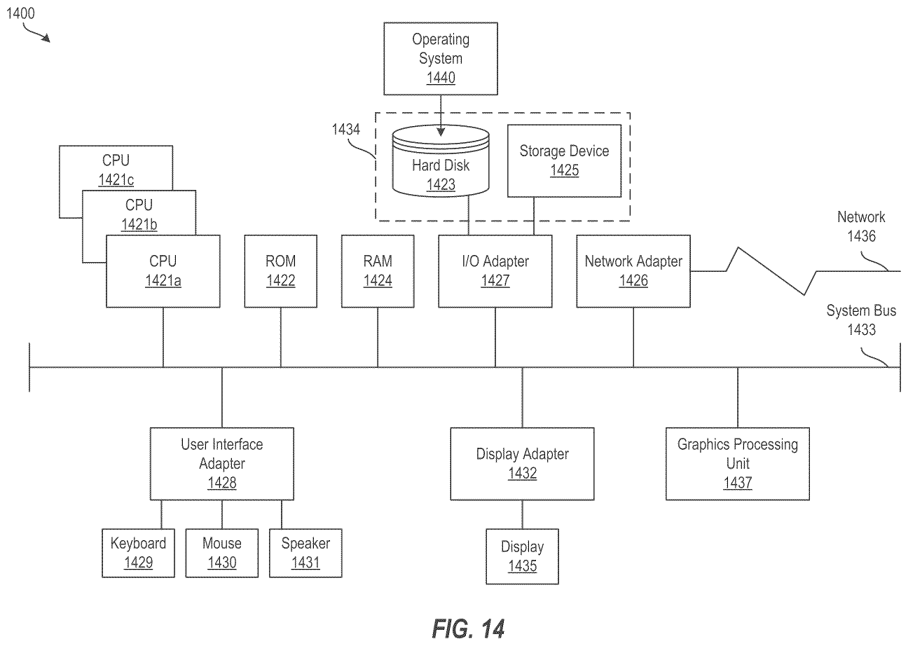

FIG. 5 is a schematic illustration of a processing system 500 for image-based localization and tracking using laser scanner data according to one or more embodiments described herein. The processing system 500 includes a processing device 502 (e.g., one or more of the processing devices 1421 of FIG. 14), a system memory 504 (e.g., the RAM 1424 and/or the ROM 1422 of FIG. 14), a network adapter 506 (e.g., the network adapter 1426 of FIG. 14), a data store 508, a sensor 510, a display 512, a SLAM and sensor fusion engine 514, a feature matching engine 516, an environmental feature detection engine 518, a tracking stabilization engine 530, a data processing and process control engine 532, and a video augmentation engine 534.

The various components, modules, engines, etc. described regarding FIG. 5 (e.g., the SLAM and sensor fusion engine 514, the feature matching engine 516, the environmental feature detection engine 518, the tracking stabilization engine 530, the data processing and process control engine 532, and/or the video augmentation engine 534) are implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein are a combination of hardware and programming. The programming is processor executable instructions stored on a tangible memory, and the hardware includes the processing device 502 for executing those instructions. Thus, the system memory 504 stores program instructions that when executed by the processing device 502 implement the engines described herein. Other engines are also utilized in various embodiments to include other features and functionality described in other examples herein.

The network adapter 506 enables the processing system 500 to transmit data to and/or receive data from other sources, such as laser scanners 520. For example, the processing system 500 receives data (e.g., a data set that includes a plurality of three-dimensional coordinates of an environment 522) from one or more of the laser scanners 520 directly and/or via a network 507. It should be appreciated that while embodiments herein describe the 3D coordinate measurement device as being a laser scanner, this is for example purposes and the claims should not be so limited. In other embodiments, the 3D coordinate measurement device is another type of system that measures a plurality of points on surfaces (i.e., generates a point cloud), such as but not limited to a triangulation scanner, a structured light scanner, or a photogrammetry device for example.

The network 507 represents any one or a combination of different types of suitable communications networks such as, for example, cable networks, public networks (e.g., the Internet), private networks, wireless networks, cellular networks, or any other suitable private and/or public networks. Further, the network 507 has any suitable communication range associated therewith and includes, for example, global networks (e.g., the Internet), metropolitan area networks (MANs), wide area networks (WANs), local area networks (LANs), or personal area networks (PANs). In addition, the network 507 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

One or more laser scanners 520 (e.g., the laser scanner 20) are arranged on, in, and/or around the environment 522 to scan the environment 522. According to one or more embodiments described herein, the laser scanners 520 include a scanner processing system including a scanner controller, a housing, and a three-dimensional (3D) scanner. The 3D scanner is disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

The laser scanners 520 perform at least one scan to generate a data set that includes a plurality of three-dimensional coordinates of the environment 522. The data set is transmitted, directly or indirectly (such as via a network) to a processing system, such as the processing system 500. It should be appreciated that other numbers of scanners (e.g., one scanner, three scanners, four scanners, six scanners, eight scanners, etc.) are used in various embodiments. According to one or more embodiments described herein, one or more scanners are used to take multiple scans. For example, one of the scanners 520 captures first scan data at a first location and then is moved to a second location, where the one of the scanners 520 captures second scan data.

Using the data received from the laser scanners 520, the processing system 500 performs image-based localization and tracking using the laser scan data. The features and functionality of the SLAM and sensor fusion engine 514, the feature matching engine 516, the environmental feature detection engine 518, the tracking stabilization engine 530, the data processing and process control engine 532, and the video augmentation engine 534 are now described in more detail with reference to the following figures.

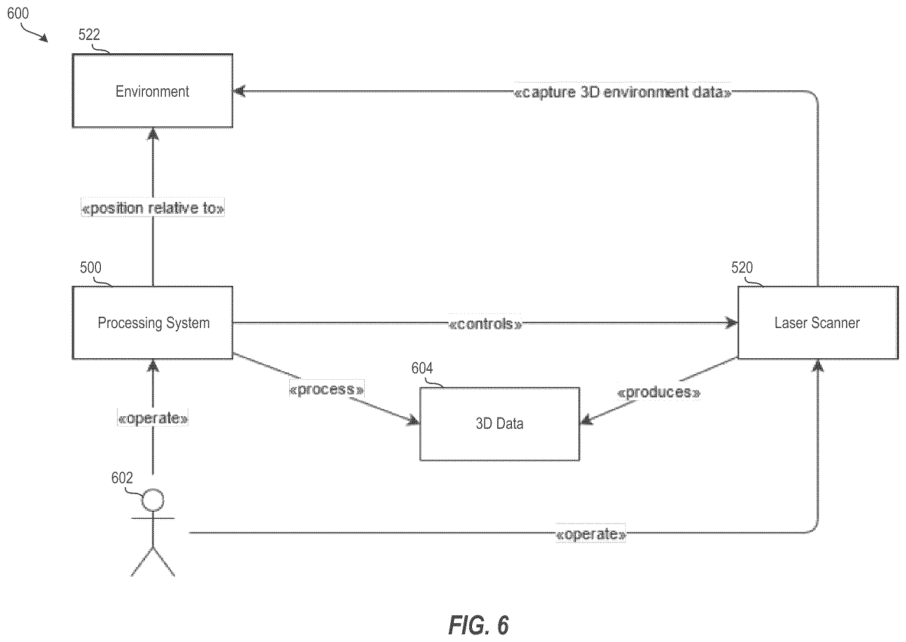

FIG. 6 is a flow diagram of a method 600 for image-based localization and tracking using laser scan data according to one or more embodiments described herein. The method 600 is performed by any suitable system or device, such as the processing system 500 of FIG. 5 and/or the processing system 1400 of FIG. 14.

A user 602 operates the processing system 500 and the laser scanner 520. For example, the user 602 places the processing system 500 and/or the laser scanner 520 in the environment 522; inputs commands, data, etc., into the processing system 500 and/or the laser scanner 520; receives data from the processing system 500 (e.g., via the display 512 of the processing system 500) and/or the laser scanner 520 (e.g., via a display (not shown) of the laser scanner 520); and the like. As an example, the user 602 uses the processing system 500 to control the 3D scanner 520 to configure the 3D scanner 520 and to cause the 3D scanner 520 to perform a scan to record the 3D data 604. In this way, the user 602 causes the laser scanner 520 to scan the environment 522 to capture 3D environmental data about the environment 522 and to store the data as 3D data 604. In various embodiments, the processing system 500 is configured to control the laser scanner 520, such as to cause the laser scanner 520 to perform a scan, etc.

The processing system 500 determines its position relative to the environment 522 using incorporated SLAM functionality. For example, the processing system 500 incorporates sensor fusion and/or SLAM capabilities and the sensor 510 (or multiple sensors) such as a camera, an inertial measurement unit, a compass, a light detecting and ranging sensor, and the like to estimate a course surface map of the environment. The captured 3D data 604 is used to complement the course mapping of the processing device 500 (determined using sensor fusion and/or SLAM capabilities) in order to provide a more stabile global frame of reference.

Having established the relative positioning of the captured 3D measurement data relative to the global frame of reference, this data is presented to the user on the display 512 of the processing system 500. This presentation leverages an AR view by overlaying the 3D data 604 into a live video stream of the environment 522 captured by a camera (e.g., the sensor 510) of the processing system 500 according to various embodiments. This provides for the user 602 to identify areas of the environment 522 where with insufficient scan coverage (e.g., areas with insufficient 3D data 604). According to various embodiments, the presentation on the display 512 of the processing system 500 is configured in such a way that areas of no or low scan point coverage are visually distinct from other areas, thus providing assistance to the user 602 in identifying areas of the environment 522 where additional 3D data is captured. This aids the user 602 in positioning the laser scanner 520 in the environment 522 for a subsequent scan (or scans).

Additional processes are also included in various embodiments, and it should be understood that the process depicted in FIG. 6 represents an illustration, and that other processes are added or existing processes are removed, modified, or rearranged in various embodiments without departing from the scope of the present disclosure.

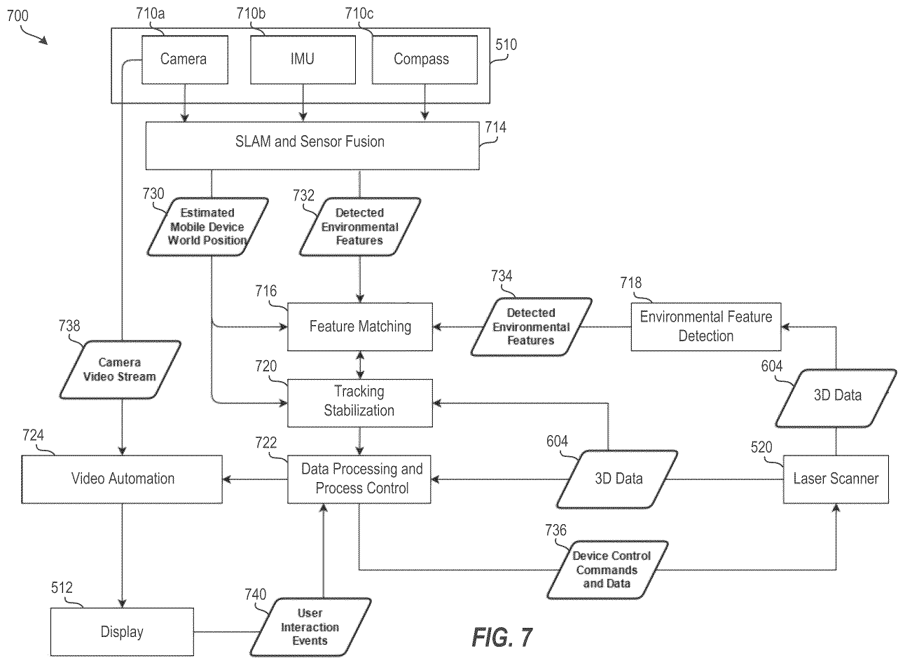

FIG. 7 depicts a flow diagram of a method 700 for image-based localization and tracking using laser scan data according to one or more embodiments described herein. The method 700 is performed by any suitable system or device, such as the processing system 500 of FIG. 5 and/or the processing system 1400 of FIG. 14.

The method 700 begins by pairing the processing system 500 to the laser scanner 520, which is further described herein. For example, a camera on the processing system 500 is used to capture an identifying indicium (e.g., a bar code, a quick response (QR) code, etc.) associated with the laser scanner 520. For example, if the laser scanner 520 includes a display (not shown), the identifying indicium is shown on the display of the laser scanner 520, and the processing system 500 captures an image of the display of the laser scanner 520 using a camera (e.g., the camera 710a). The processing system 500 accesses a data repository to determine characteristics about the laser scanner 520 based on the identifying indicium.

The method 700 uses data received from at least two separate sources: the processing system 500 and the laser scanner 520. It should be appreciated that additional sources of data are implemented in various embodiments, such as multiple processing systems, multiple laser scanners, and the like.

The processing system 500 provides a live video (e.g., camera video stream 738) using the camera 710a. The processing system 500 also performs a localization of its position (e.g., estimated mobile device world position 730) within an artificial world coordinate system using data received from the sensor 510 (which are one or more sensors). For example, the processing system 500 senses aspects of the environment 522 using the sensor 510. The sensor 510 includes one or more sensors and/or one or more sensor arrays. The sensor 510 includes one or more of a camera 710a, an inertial measurement unit (IMU) 710b, a compass 710c, a light detection and ranging (lidar) sensor, and the like. Using the sensed aspects of the environment 522, the processing system 500, using the SLAM and sensor fusion engine 514, performs SLAM and sensor fusion at block 714. The SLAM and sensor fusion engine 514 fuse datas from multiple sources, such as two or more of the sensors 710a, 710b, 710c, etc., to integrate the data to provide more accurate information than is provided by one of the sensors individually. The SLAM and sensor fusion engine 514 uses data from one or more of the sensors 510 and/or fused data to perform SLAM. As described herein, SLAM is used to construct or update a map of an unknown environment (e.g., the environment 522) while simultaneously tracking the location of the processing system 500 within the environment. The SLAM and sensor fusion engine 514 generates the estimated mobile device world position 730 and detected environmental features 732. The detected environmental features 732 include detected objects (e.g., a shape, a plane, etc.) within the environment 522. For example, feature detection is performed on one or more images or datasets (e.g., a point cloud), such as using a trained machine learning model or other suitable image recognition techniques, to detect one or more objects within the environment 522.

The laser scanner 520 provides captured 3D data (e.g., the 3D data 604) that are captured using one or more of the techniques described herein for capturing such data or other suitable techniques. The 3D data 604 includes captured 3D measurement data about the environment 522. For example, the laser scanner 520 (or multiple laser scanners) are positioned within or proximity to the environment 522, and the laser scanner 520 (or multiple laser scanners) perform a scan of the environment 522 to capture the 3D data 604 about the environment. The 3D data 604 are captured in a coordinate system relative to an origin defined by the laser scanner 520. That is, the 3D data 604 are captured in a coordinate system of the laser scanner 520, which differs from the mobile device world coordinate system for the processing system 500. The lasers scanner 520 and/or the processing system 500 perform environmental feature detection at block 718 on the 3D data 604 to detect objects within the environment 522, resulting in detected environmental features 734. Feature detection is performed on one or more images or datasets (e.g., a point cloud), such as using a trained machine learning model or other suitable image recognition techniques, to detect one or more objects within the environment 522.

In order to bring the external 3D measurement frames into the world coordinate system established by the smart mobile device, a relative transformation between them is determined. To this end, method 700 uses features detected by the SLAM and sensor fusion engine 514 on the processing system 500 and matches those features against the 3D data 604. From this matching, an estimated pose of the laser scanner 500, in the global coordinate frame, is determined, which provides for the processing system 500 to display (on the display 512) the 3D data 604 alongside the detected environmental features 732 in a common view featuring the live camera feed. That is, an “augmented reality” (AR) representation of the 3D data 604 is provided for the environment 522.

For example, once the data are received from the processing system 500 (e.g., the data from the sensors 510) and the laser scanner 520 (e.g., the 3D data 604), the processing system 500 (e.g., using the feature matching engine 516) is perform feature matching at block 716. That is, the feature matching engine 516 compares the detected environmental features 732 (from the sensors 510 of the processing system 500) with the detected environmental features 734 (from the 3D data 604 captured by the laser scanner 520) to establish correspondences between the processing system 500 and the laser scanner 520. For example, the features 734, 718 are compared to identify the same objects in the environment 522 to orient the processing system 500 and the laser scanner 520 relative to one another. This effectively brings together the two coordinate systems, namely the coordinate systems of the laser scanner 520 and the processing system 500. This improves tracking and/or stability of the processing system 500 within the environment 522, thus representing an improvement to the functioning of the processing system 500. For example, at block 720, tracking stabilization is performed by the tracking stabilization engine 530 using the estimated mobile device world position 730 and the 3D data 604. Commonly owned U.S. patent application Ser. No. 17/845,482 entitled TRACKING WITH REFERENCE TO A WORLD COORDINATE SYSTEM filed in the name of Parian et al. on Jun. 21, 2022, which is incorporated by reference herein in its entirety, provides examples of techniques for performing initialization and tracking.

More particularly, the tracking stabilization engine 532 leverages the 3D data 604 from the laser scanner 520 to improve upon the coarse positioning from the positioning determined by the processing device 500 using the SLAM and sensor fusion engine 514 (at block 714). This occurs by registering subsequent frames of the 3D data 604 against each other (e.g., each time determining a relative pose between the registered frames) while using the features (e.g., the detected environmental features 732) detected on the processing system 500 to determine an initial “guess” for the relative pose of the processing system 500, thereby reducing the chance of registration ambiguities and improving the convergence of the registration. Thus, using this tracking stabilization engine 530, a more robust global coordinate system is established. The global coordinate system is more robust compare to the estimated global coordinate system from the SLAM framework (e.g., the SLAM and sensor fusion engine 514) of the processing system 500.

At block 722, the data processing and process control engine 532 performs data processing and process control using results of the tracking stabilization (block 720) and the 3D data 604. Data processing and process control are performed by the processing system 500, the laser scanner 520, another device (e.g., a node of a cloud computing system), and/or combinations thereof. Data processing includes, for example, generating an augmented reality representation of the 3D data 604 using the video augmentation engine 534, or any other suitable data processing. Process control includes controlling any components, elements, features, etc. of the processing system 500, the laser scanner 520, etc. At block 740, a user provides user interaction events as inputs to the data processing and process control engine 532 to cause one or more of the processing system 500 and/or the laser scanner 520 to perform a task (e.g., perform a scan by the laser scanner 520), to alter a configuration parameter (e.g., a setting on the laser scanner 520), etc.

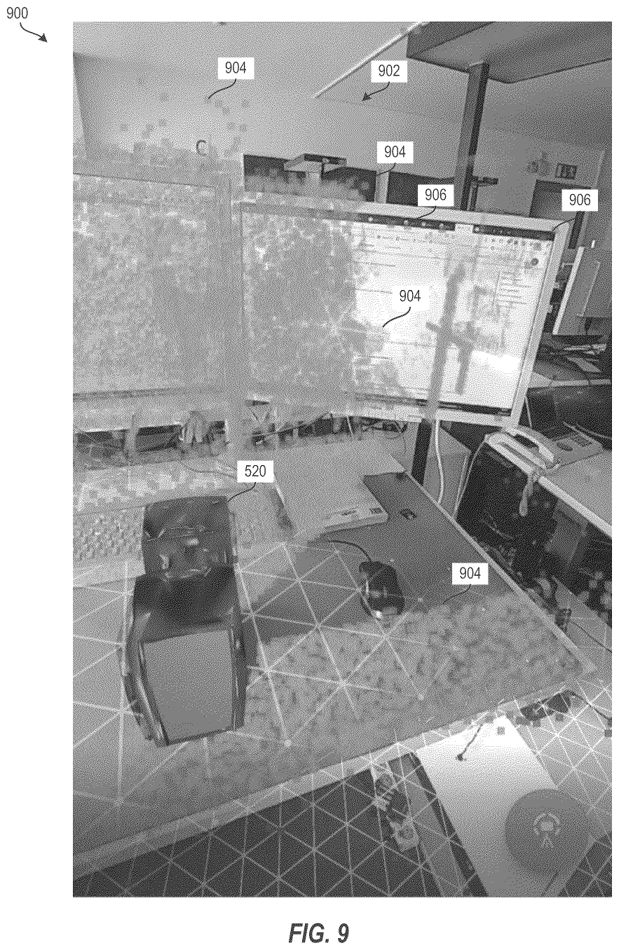

The video augmentation engine 534 uses the 3D data 604 (received via the data processing and process control block 722, for example) to generate an augmented reality representation of the 3D data 604 and overlays the AR view onto the camera video stream 738 captured by the camera 710a. AR representations are further described herein, such as with reference to FIG. 9.

Additional processes are also included in various embodiments, and it should be understood that the process depicted in FIG. 7 represents an illustration, and that other processes are added or existing processes are removed, modified, or rearranged in various embodiments without departing from the scope of the present disclosure.

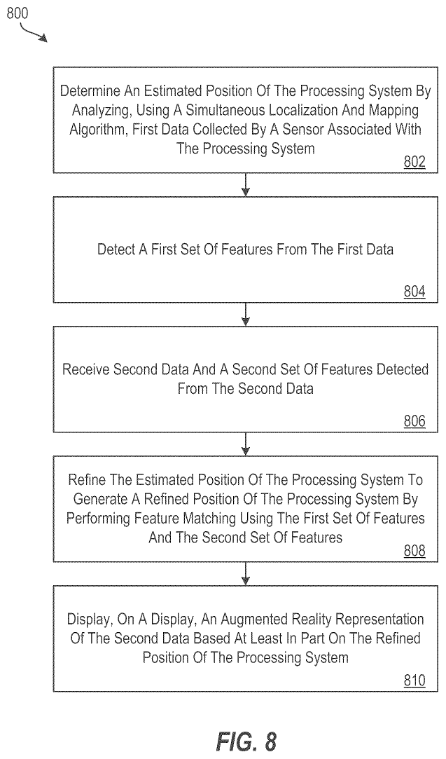

Turning now to FIG. 8, a flow diagram of a method 800 for image-based localization and tracking using laser scan data is provided according to one or more embodiments described herein. The method 800 is performed by any suitable system or device, such as the processing system 500 of FIG. 5 and/or the processing system 1400 of FIG. 14.

At block 802, the processing system 500 (e.g., using the SLAM and sensor fusion engine 514) determines an estimated position of the processing system 500. This is done by analyzing, using a SLAM algorithm, first data collected by the sensor 510 associated with the processing system 500. At block 804, the processing system 500 (e.g., using the environmental feature detection engine 518) detects a first set of features from the first data. At block 806, the processing system 500 (e.g., using the network adapter 506) receives second data and a second set of features detected from the second data. At block 808, the processing system 500 (e.g., using the feature matching engine 516) refines the estimated position of the processing system 500 to generate a refined position of the processing system 500 by performing feature matching using the first set of features and the second set of features. At block 810, the processing system 500 (e.g., using the video augmentation engine 534) displays, on the display 512, an augmented reality representation of the second data based at least in part on the refined position of the processing system 500.

Additional processes are also included, and it should be understood that the process depicted in FIG. 8 represents an illustration, and that other processes are added or existing processes are removed, modified, or rearranged in various embodiments without departing from the scope of the present disclosure.

Turning now to FIG. 9, a graphical representation of an interface 900 is depicted that shows an augmented reality representation of an environment 902 according to one or more embodiments described herein. In this example, the view of the environment 902 is generated using the camera 710a of the processing system 500. The individual points 904 represent AR elements generated from the 3D data 604. The laser scanner 520 is also shown. The individual points 906 represent the detected environmental features 732 described herein.

One or more embodiments for stabilized location tracking for augmented reality visualization of 3D measurement data (e.g., the 3D data 604) is provided. In some cases, it is desirable to capture (e.g., using the laser scanner 520) 3D data at different locations throughout or proximate to an environment (e.g., the environment 522). Determining a “good” initial guess for the relative positioning of new frames of 3D data with respect to previously captured frames/data of an environment is challenging. Further, providing a stable global coordinate system when visualizing 3D data in an augmented reality scene is also challenging.

One or more embodiments described herein address these challenges by providing techniques for visualizing 3D data 604 (e.g., measurement data) in an augmented reality representation in such a way that improved stability between a video stream (e.g., camera video stream 738 captured by the camera 710a of the processing system 500) and the 3D data 604 is realized.

In order to visualize the 3D data 604 from the laser scanner 520 in an AR view/representation on the display 512 of the processing system 500, a relative pose of the 3D data 604 is determined with respect to some reference in the coordinate system established by the processing system 500. This relative positioning is realized by matching detected features from the SLAM and sensor fusion engine 514 of the processing system 500. Examples of detected features include, but are not limited to, planes, corner points, markers, matched images, etc. If sufficient features are recognized in the environment 522 (based on the data received from the sensor(s) 510) and in the 3D data 604, a position is determined automatically in some examples or, in other examples, an initial guess of the position of the laser scanner 520 with respect to the processing system 500 is also established by an operator of the processing system 500/laser scanner 520.

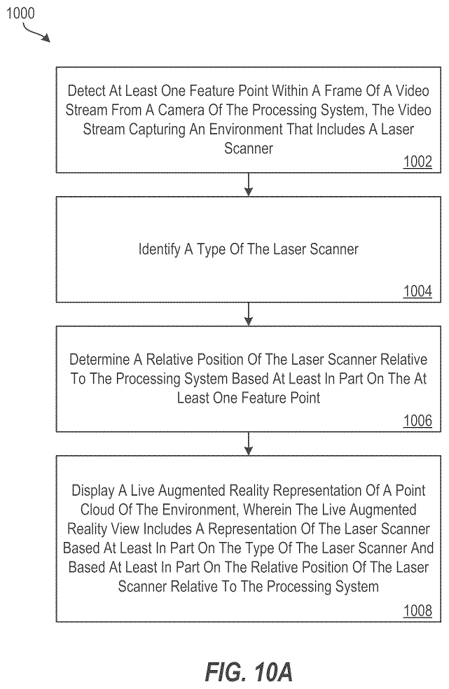

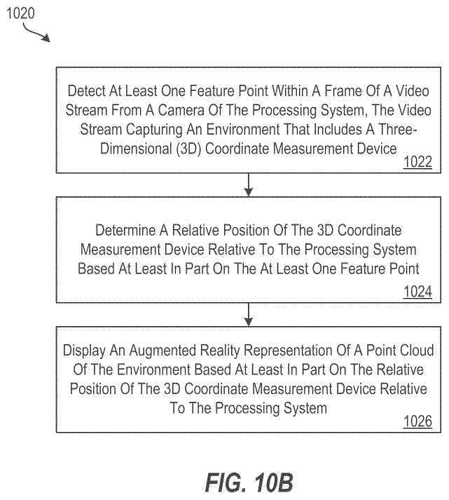

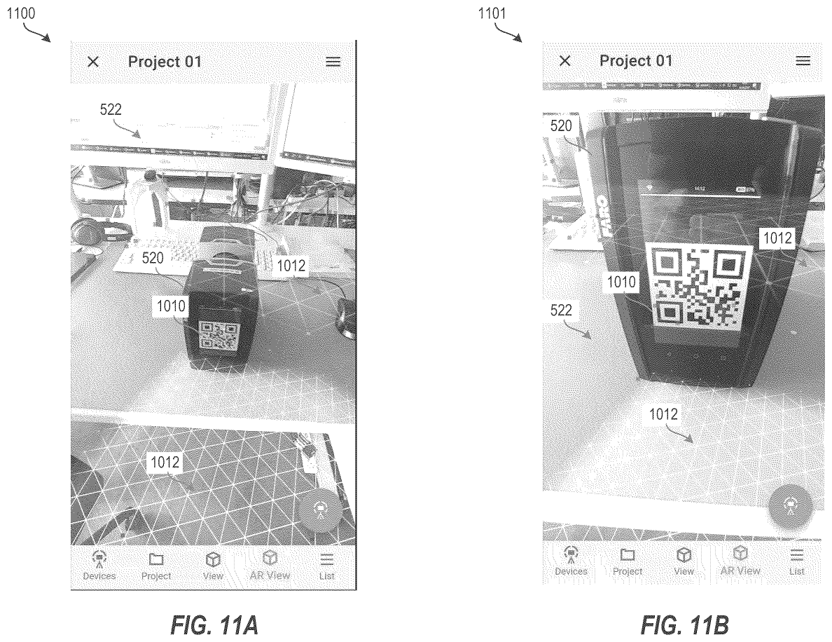

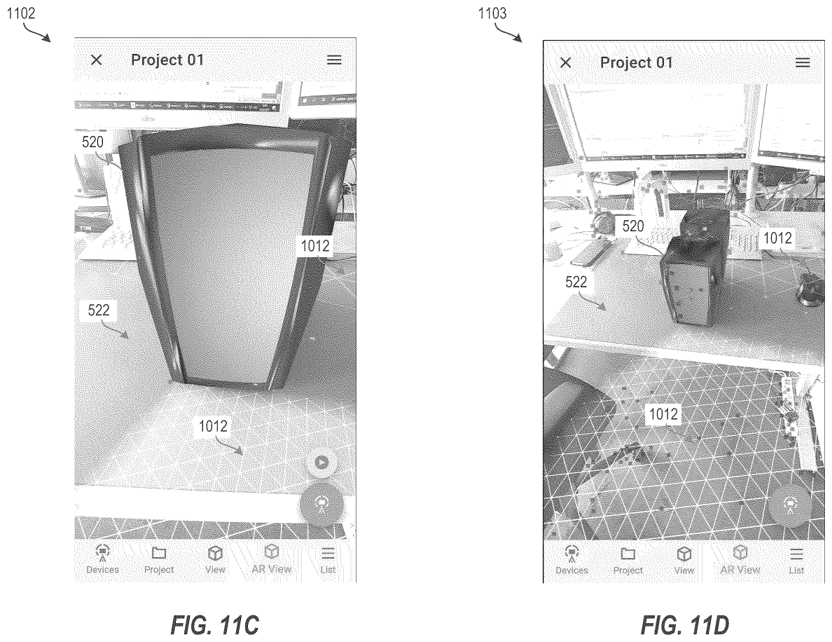

FIG. 10A is a flow diagram of a method 1000 for image-based localization and tracking using laser scanner data according to one or more embodiments described herein. The method 1000 is performed by any suitable system or device, such as the processing system 500 of FIG. 5 and/or the processing system 1400 of FIG. 14. The method is now described with reference to FIGS. 5-7 and FIGS. 11A-11D. In particular, FIGS. 11A-11D depict screen shots 1000-1003 of an augmented reality view according to one or more embodiments described herein.

With reference to FIG. 10A, at block 1002, the processing system 500 detects at least one feature point within a frame of a video stream (e.g., the camera video stream 738) from a camera (e.g., the camera 710a) of the processing system 500, the video stream capturing an environment that includes a laser scanner. With reference to FIG. 11A, a screenshot 1100 shows an augmented reality view over laid on a video stream of an environment, such as the environment 522. The screenshot shows the laser scanner 520 having a unique identifier 1010 associated therewith. The screenshot 1100 also shows a feature point as planes 1012. The planes 1012 are examples of features that are used to perform feature mapping as described herein. For example, the planes represent surfaces within the environment 522. The feature mapping includes, for example, surface mapping.

With continued reference to FIG. 10A, at block 1004, the processing system 500 identifies a type of the laser scanner (e.g., the laser scanner 520). According to an example, the processing system 500 identifies the type of the laser scanner based at least in part on a unique identifier associated with the laser scanner. For example, an identifier, such as a quick response (QR) code, bar code, or other similar visual identifier, is affixed or otherwise associated with the laser scanner 520. The identifier provides information about the laser scanner 520, such as a type of the laser scanner, a model of the laser scanner, a serial number of the laser scanner, etc. The processing system 500 receives information from the unique identifier, such as by scanning the unique identifier with the camera 710a. For example, the processing system 500, using the camera 710a, captures an image of the unique identifier (e.g., a QR code), decodes the QR code to extract information, and determines an identity of the laser scanner 520 from the extracted information. The unique identifier takes different forms in various embodiments, such as a sticker applied to the laser scanner 520, a display of the laser scanner 520 displaying the unique identifier, an electronic unique identifier, and the like. According to one or more embodiments described herein, the processing system 500 uses the extracted information from the identifier (e.g., a serial number of the laser scanner 520) to retrieve other information about the laser scanner 520, such as capabilities, etc., from a database. According to one or more embodiments described herein, the unique identifier is an electronic identifier, such as a radio frequency identifier (RFID) chip, near field communications (NFC) chip, or other similar device. In such cases, the processing system 500 is equipped to receive information from the electronic identifier, such as by wired and/or wireless communications. With reference to FIG. 11B, a screenshot 1102 shows the augmented reality view over laid on a video stream of the environment 522. In this figure, the unique identifier 1010 is shown in more detail as the camera 710a of the processing system 500 moves closer to the laser scanner 520. Particularly, in this example, the unique identifier 1010 is a QR code that is displayed on a display of the laser scanner 520. The camera 710a captures an image of the unique identifier 1010 or otherwise scan the unique identifier 1010. As another example, the processing system 500 identifies the type of the laser scanner 520 using the physical shape of the scanner or some other characteristic of the laser scanner without using a unique identifier.

With continued reference to FIG. 10A, at block 1006, the processing system 500 determines a relative position of the laser scanner 520 relative to the processing system 500 using the at least one feature point (block 1002), which is performed as described herein. For example, the processing system 500 uses a simultaneous localization and mapping algorithm to determine an approximate position of the processing system 500. Then, the processing system 500 performs feature matching to match features between data captured by the processing system 500 and data (e.g., the 3D data 604) captured by the laser scanner 520.

At block 1008, the processing system 500 displays, on a display (e.g., the display 512), a live augmented reality representation of a point cloud of the environment. According to one or more embodiments described herein, the live augmented reality view includes a representation of the laser scanner 520 based at least in part on the type of the laser scanner 520 and based at least in part on the relative position of the laser scanner 520 relative to the processing system 500. With reference to FIGS. 11C and 11D, screenshots 1102 and 1103 show the augmented reality view where the laser scanner 520 is depicted as a representation of the laser scanner 520. It should be appreciated that any suitable model, such as a computer aided design (CAD) model, is used to represent the laser scanner 520, such as shown in FIGS. 11C and 11D. According to one or more embodiments described herein, the displaying at block 1008 further includes displaying a visual analysis result along with the point cloud. The visual analysis result are at least one of a color (e.g., based on point cloud density), a symbol (e.g., to show density or completion status), or text (e.g., to indicate density).

Additional processes are also included, and it should be understood that the process depicted in FIG. 10A represents an illustration, and that other processes are added or existing processes are removed, modified, or rearranged in various embodiments without departing from the scope of the present disclosure.

FIG. 10B depicts a flow diagram of a method 1020 for displaying an AR representation of a point cloud according to one or more embodiments described herein. The method 1020 is performed by any suitable system or device, such as the processing system 500 of FIG. 5 and/or the processing system 1400 of FIG. 14. At block 1022, the processing system detects at least one feature point within a frame of a video stream from a camera of the processing system. The video stream captures an environment that includes a 3D coordinate measurement device. At block 1024, the processing system determines a relative position of the 3D coordinate measurement device relative to the processing system based at least in part on the at least one feature point. At block 1024, the processing system displays an augmented reality representation of a point cloud of the environment based at least in part on the relative position of the 3D coordinate measurement device relative to the processing system. Additional processes are also included, and it should be understood that the process depicted in FIG. 10B represents an illustration, and that other processes are added or existing processes are removed, modified, or rearranged in various embodiments without departing from the scope of the present disclosure.

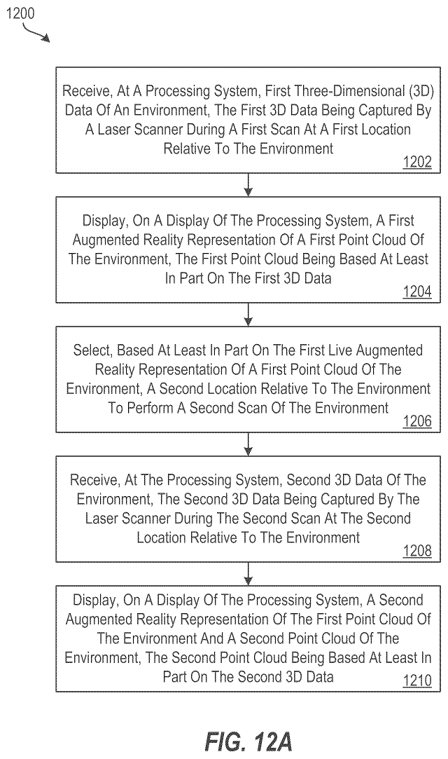

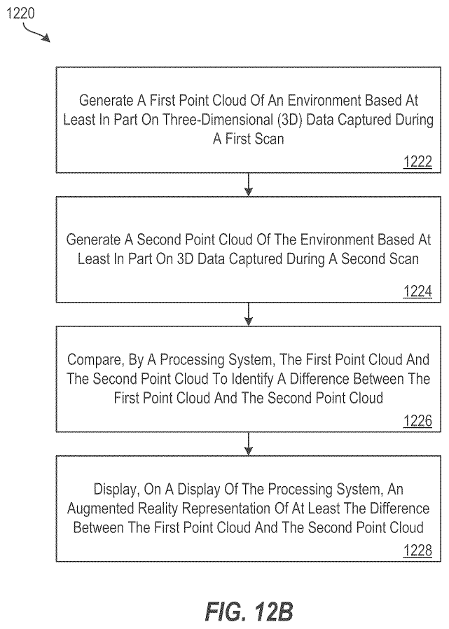

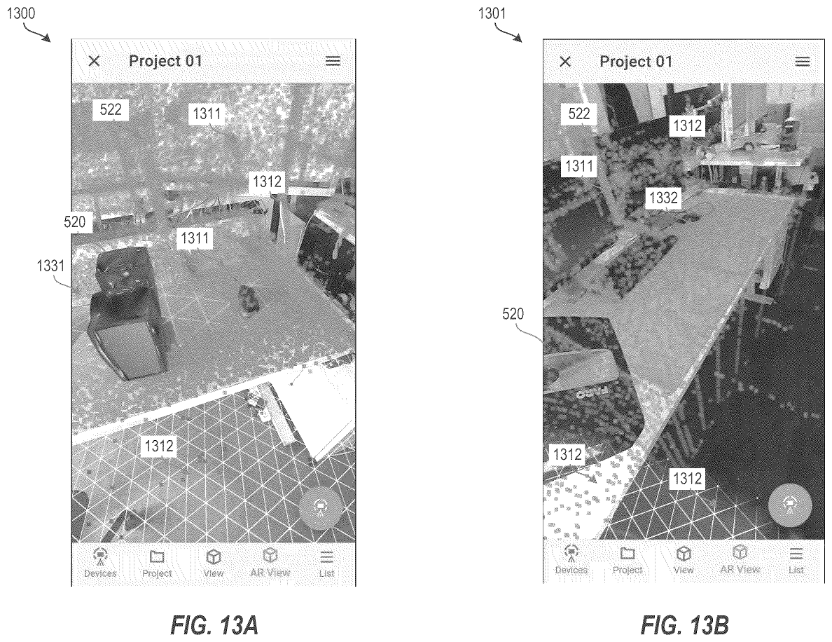

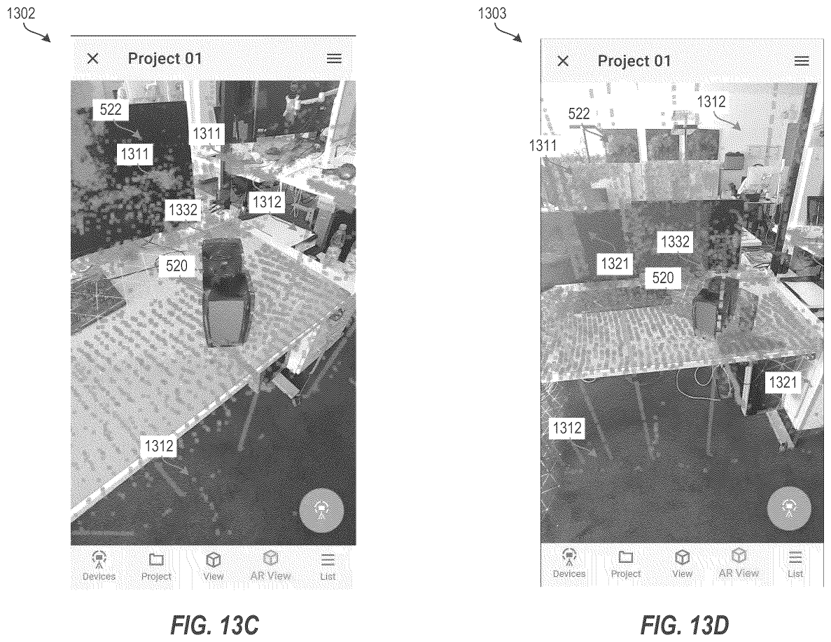

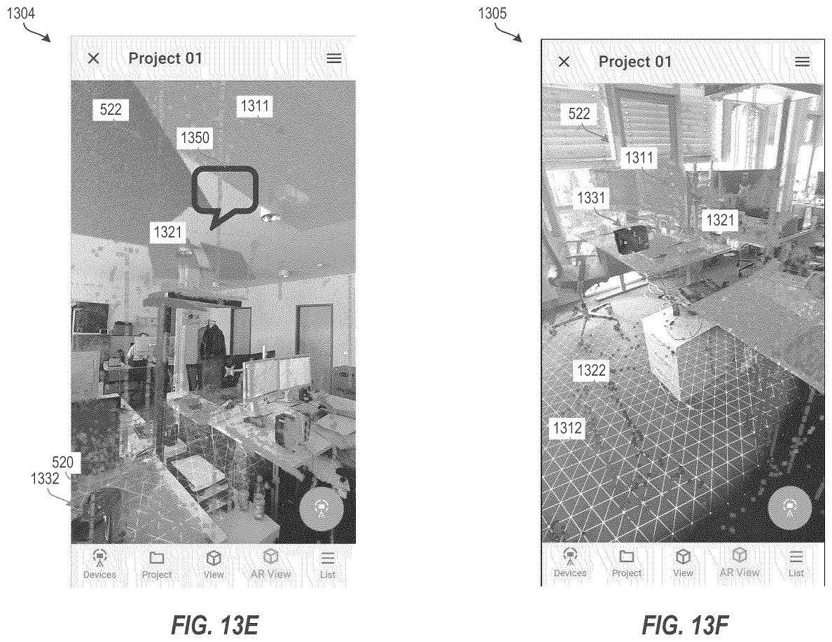

Turning now to FIG. 12A, a flow diagram of a method 1200 for comparing three-dimensional (3D) data using augmented reality is provided according to one or more embodiments described herein. The method 1200 is performed by any suitable system or device, such as the processing system 500 of FIG. 5 and/or the processing system 1400 of FIG. 14. The method is now described with reference to FIGS. 5-7 and FIGS. 13A-13F. In particular, FIGS. 13A-13F depict screen shots of an augmented reality view according to one or more embodiments described herein.

At block 1202, the processing system 500 receives first three-dimensional (3D) data (e.g., 3D data 604) of an environment (e.g., the environment 522). In an embodiment, the first 3D data are captured by a laser scanner (e.g., the laser scanner 520) during a first scan at a first location relative to the environment. For example, as shown in FIG. 13A, the laser scanner 520 captures 3D data of the environment 522 at a location 1331. That is, the laser scanner 520 is positioned within the environment 522 at the location 1331 and captures the scan data from that location. It should be appreciated that while embodiments herein refer to a 3D coordinate measurement device as a laser scanner, this is for example purposes and the claims should not be so limited. In other embodiments, other types of optical measurement devices are used, such as but not limited to triangulation scanners and structured light scanners for example.

With continued reference to FIG. 12A, at block 1204, the processing system 500 displays, on the display 512, a first augmented reality representation of a first point cloud of the environment. The first point cloud is based at least in part on the first 3D data. The displaying first augmented reality representation of the first point cloud of the environment includes overlaying, on the display, the first point cloud onto a video stream captured by a camera of the processing system. For example, in FIG. 13A an example of a first point cloud 1311 is displayed on the display 512 as an augmented reality representation. The first point cloud 1311 is shown in FIG. 13A, et seq., by blue dots that form the first point cloud 1311. Regions 1312 between the blue dots that form the first point cloud 1311 represent areas of the environment 522 where 3D data was not captured and/or where 3D data is sparse.

With continued reference to FIG. 12A, at block 1206, a second location relative to the environment is selected to perform a second scan of the environment. The selection is based at least in part on the first live augmented reality representation of a first point cloud of the environment according to various embodiments. For example, a user makes or aids in the selection, such as by selecting the second location based at least in part on the first live augmented reality representation. That is, the user views the first live augmented reality representation and selects the second location based on the augmented reality representation. As an example, the user selects the second location based on how much (or little) coverage the 3D data provides of the environment. For example, with reference to FIGS. 13A and 13B, it is shown that the regions 1312 have sparse coverage compared to the other areas that make up the point cloud 1311. The user selects one of the regions 1312 as the second location 1322.

As another example, selecting the second location are based at least in part on a density of the first point cloud. For example, the point cloud 1311 is analyzed by the processing system 500, and the processing system 500 selects the second location 1332 by identifying one or more regions of the point cloud 1311 with relatively sparse coverage. According to various embodiments, the processing system 500 makes the selection of the second location based on one or more of the following factors: point cloud density, distance from the first location, a desired point cloud density, user feedback, and/or other considerations, including combinations thereof.

Once the location 1332 is selected, the laser scanner 520 is moved from the location 1331 to the location 1332 to perform a second scan of the environment 522.

With continued reference to FIG. 12A, at block 1208, the processing system 500 receives second 3D data (e.g., the 3D data 604) of the environment (e.g., the environment 522). The second 3D data are captured by the laser scanner (e.g., the laser scanner 520) during the second scan at the second location (e.g., the location 1332) relative to the environment. For example, FIG. 13C shows the laser scanner 520 located at the location 1332. Once placed at the location 1332, the laser scanner 520 is associated with the processing system 500, such as using the techniques described herein (see, e.g., FIG. 10A and the associated description). The laser scanner 520 begins scanning the environment 522 and capturing second 3D data.

At block 1210, the processing system 500 displays, on the display 512, a second augmented reality representation of the first point cloud of the environment and a second point cloud of the environment. The second point cloud is based at least in part on the second 3D data. For example, with reference to FIGS. 13D-13F, an example of the first point cloud 1311 and the second point cloud 1321 is displayed on the display 512. The first point cloud 1311 is shown blue dots that form the first point cloud 1311; the second point cloud 1321 is shown by purple dots that form the second point cloud 1321. As described, the regions 1312 between the blue dots that form the first point cloud 1311 represent areas of the environment 522 where 3D data was not captured and/or where 3D data is sparse. As is shown in FIGS. 13D-13F, one or more of the regions 1312 are captured by the second 3D data of the second scan (see particularly FIG. 13E).

Additional processes are also included in the method 1200 in various embodiments. For example, the first augmented reality view includes a representation of the laser scanner (e.g. a CAD model). In examples as described herein, the representation of the laser scanner is based at least in part on a type of the laser scanner and/or a relative position of the laser scanner relative to the processing system.

According to one or more embodiments described herein, the first augmented reality representation and/or the second augmented reality representation is live augmented reality representations of the environment.

According to one or more embodiments described herein, a user annotates one or more of the first and/or the second augmented reality representations. The processing system 500 then associates the annotation with at least a portion of the first point cloud or the second point cloud. For example, the example of FIG. 13E shows an annotation 1350, which include text, images, audio, video, etc. from a user. For example, the user provides text indicating that a particular area of the environment 522 has sparse coverage.

According to one or more embodiments described herein, the method 1200 further includes the processing system generating an estimated topology of the environment, such as using SLAM techniques as described herein. The estimated topology is then compared to the first point cloud, and it is determined whether a deviation exists between the first point cloud and the estimated topology. For example, if a certain number or percentage of points of the point cloud fail to satisfy a threshold (e.g., a distance) relative to corresponding points of the estimated topology, it is determined that a deviation exists between the first point cloud and the estimated topology. Determining whether a deviation exists between the first point cloud and the estimated topology provides many advantages. For example, when a deviation exists, an indication is generated of the deviation, such as providing a prompt (e.g., a text message, an augmented reality element, etc.) on the display 512, and/or an action is taken, such as causing the laser scanner 520 to perform a new scan. In some cases, when a deviation exists, a new scan is performed automatically. Thus, when something in the environment has changed, the captured data is updated. Alternatively, or in addition, the deviation is logged in order to provide a list of changes. Alternatively, or in addition, a four-dimensional model (e.g., three positional dimensions (e.g., X,Y,Z) and a temporal dimension) is created to prepare a journey in time (e.g., enable a user see changes that were done in a construction site over time). Alternatively, or in addition, the deviation indicates a failed registration, and different locations are compared to each other. The operator is informed accordingly.

According to various embodiments, the comparison includes comparing a distance, such as a Euclidean distance, between one or more points of the point cloud to one or more corresponding points of the estimated topology. If the distance is greater than a threshold amount, a deviation is said to exist. In the case of multiple points, the distances are averaged, a median distance is used, etc. in accordance with various embodiments. As another example, if a certain number of the points fall outside a threshold standard deviation (e.g., 2 standard deviations), a deviation is said to exist. Other examples are also possible.

It should be understood that the process depicted in FIG. 12 represents an illustration, and that other processes are added or existing processes are removed, modified, or rearranged in various embodiments without departing from the scope of the present disclosure.

FIG. 12B is a flow diagram of a method 1220 for comparing three-dimensional (3D) data using augmented reality according to one or more embodiments described herein. The method 1220 is be performed by any suitable system or device, such as the processing system 500 of FIG. 5 and/or the processing system 1400 of FIG. 14. At block 1222, the processing system generates a first point cloud of an environment based at least in part on three-dimensional (3D) data captured during a first scan. The first scan is performed, for example, by the laser scanner 520 or another suitable 3D coordinate measurement device. At block 1224, the processing system generates a second point cloud of the environment based at least in part on 3D data captured during a second scan. The first scan is performed, for example, by the processing system 500 or another suitable device using a LIDAR sensor. At block 1224, the processing system compares the first point cloud and the second point cloud to identify a difference between the first point cloud and the second point cloud. Differences result in changes that occur within an environment over time, such as due to construction, rearranging objects within the environment, and/or the like, including combinations and/or multiples thereof. At block 1226, the processing system displays, on a display of the processing system, an augmented reality representation of at least the difference between the first point cloud and the second point cloud. Additional processes are also included in various embodiments, and it should be understood that the process depicted in FIG. 12B represents an illustration, and that other processes are added or existing processes are removed, modified, or rearranged in various embodiments without departing from the scope of the present disclosure.

It is understood that one or more embodiments described herein is capable of being implemented in conjunction with any other type of computing environment now known or later developed. For example, FIG. 14 depicts a block diagram of a processing system 1400 for implementing the techniques described herein. In accordance with one or more embodiments described herein, the processing system 1400 is an example of a cloud computing node of a cloud computing environment. In examples, processing system 1400 has one or more central processing units (“processors” or “processing resources” or “processing devices”) 1421a, 1421b, 1421c, etc. (collectively or generically referred to as processor(s) 1421 and/or as processing device(s)). In aspects of the present disclosure, each processor 1421 includes a reduced instruction set computer (RISC) microprocessor. Processors 1421 are coupled to system memory (e.g., random access memory (RAM) 1424) and various other components via a system bus 1433. Read only memory (ROM) 1422 is coupled to system bus 1433 and includes a basic input/output system (BIOS), which controls certain basic functions of processing system 1400.

Further depicted are an input/output (I/O) adapter 1427 and a network adapter 1426 coupled to system bus 1433. In various embodiments, I/O adapter 1427 is a small computer system interface (SCSI) adapter that communicates with a hard disk 1423 and/or a storage device 1425 or any other similar component. I/O adapter 1427, hard disk 1423, and storage device 1425 are collectively referred to herein as mass storage 1434. Operating system 1440 for execution on processing system 1400 is stored in mass storage 1434 according to an embodiment. The network adapter 1426 interconnects system bus 1433 with an outside network 1436 enabling processing system 1400 to communicate with other such systems.

A display (e.g., a display monitor) 1435 is connected to system bus 1433 by display adapter 1432, which includes a graphics adapter to improve the performance of graphics intensive applications and a video controller. In one aspect of the present disclosure, adapters 1426, 1427, and/or 1432 are connected to one or more I/O busses that are connected to system bus 1433 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1433 via user interface adapter 1428 and display adapter 1432. According to embodiments, keyboard 1429, mouse 1430, and speaker 1431 are interconnected to system bus 1433 via user interface adapter 1428, which includes, for example, a Super I/O chip integrating multiple device adapters into a single integrated circuit.

In some aspects of the present disclosure, processing system 1400 includes a graphics processing unit 1437. Graphics processing unit 1437 is a specialized electronic circuit designed to manipulate and alter memory to accelerate the creation of images in a frame buffer intended for output to a display. In general, graphics processing unit 1437 is very efficient at manipulating computer graphics and image processing, and has a highly parallel structure that makes it more effective than general-purpose CPUs for algorithms where processing of large blocks of data is done in parallel.

Thus, as configured herein, processing system 1400 includes processing capability in the form of processors 1421, storage capability including system memory (e.g., RAM 1424), and mass storage 1434, input means such as keyboard 1429 and mouse 1430, and output capability including speaker 1431 and display 1435. In some aspects of the present disclosure, a portion of system memory (e.g., RAM 1424) and mass storage 1434 collectively store the operating system 1440 to coordinate the functions of the various components shown in processing system 1400.

It will be appreciated that one or more embodiments described herein are embodied as a system, method, or computer program product and take the form of a hardware embodiment, a software embodiment (including firmware, resident software, micro-code, etc.), or a combination thereof. Furthermore, one or more embodiments described herein take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” includes a range, such as of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

In one exemplary embodiment, a method is provided. The method includes determining, by a processing system, an estimated position of the processing system by analyzing, using a simultaneous localization and mapping algorithm, first data collected by a sensor associated with the processing system. The method further includes detecting, by the processing system, a first set of features from the first data. The method further includes receiving, by the processing system, second data and a second set of features detected from the second data. The method further includes refining, by the processing system, the estimated position of the processing system to generate a refined position of the processing system by performing feature matching using the first set of features and the second set of features. The method further includes displaying, on a display of the processing system, an augmented reality representation of the second data based at least in part on the refined position of the processing system.

In addition to one or more of the features described herein, or as an alternative, further embodiments of the method include that the second data is obtained by scanning the environment using a three-dimensional (3D) coordinate measurement device.

In addition to one or more of the features described herein, or as an alternative, further embodiments of the method include that the 3D coordinate measurement device is a laser scanner.

In addition to one or more of the features described herein, or as an alternative, further embodiments of the method include controlling, by the processing system, the 3D coordinate measurement device.

In addition to one or more of the features described herein, or as an alternative, further embodiments of the method include that the second data is three-dimensional measurement data.

In addition to one or more of the features described herein, or as an alternative, further embodiments of the method include that refining the estimated position of the processing system to generate the refined position of the processing system further includes performing tracking stabilization using the second data.

In addition to one or more of the features described herein, or as an alternative, further embodiments of the method include that the sensor is a camera.

In addition to one or more of the features described herein, or as an alternative, further embodiments of the method include that the sensor is an inertial measurement unit.

In addition to one or more of the features described herein, or as an alternative, further embodiments of the method include that the sensor is a compass.

In addition to one or more of the features described herein, or as an alternative, further embodiments of the method include: performing tracking stabilization using the estimated position of the processing system and the second data.

In addition to one or more of the features described herein, or as an alternative, further embodiments of the method include that performing tracking stabilization using the refined position of the processing system and the second data.

In another exemplary embodiment, a system is provided. The system includes a memory having computer readable instructions a processing device for executing the computer readable instructions. The computer readable instructions control the processing device to perform operations. The operations include determining an estimated position of the processing system by analyzing, using a simultaneous localization and mapping algorithm, first data collected by a sensor associated with the processing system. The operations further include detecting a first set of features from the first data. The operations further include receiving second data and a second set of features detected from the second data. The operations further include refining the estimated position of the processing system to generate a refined position of the processing system by performing feature matching using the first set of features and the second set of features. The operations further include causing to be displayed, on a display, an augmented reality representation of the second data based at least in part on the refined position of the processing system.

In addition to one or more of the features described herein, or as an alternative, further embodiments of the system include that the second data is obtained by scanning the environment using a three-dimensional (3D) coordinate measurement device.

In addition to one or more of the features described herein, or as an alternative, further embodiments of the system include that the 3D coordinate measurement device is a laser scanner.

In addition to one or more of the features described herein, or as an alternative, further embodiments of the system include that the operations further include controlling the 3D coordinate measurement device.

In addition to one or more of the features described herein, or as an alternative, further embodiments of the system include that the second data is three-dimensional measurement data.

In addition to one or more of the features described herein, or as an alternative, further embodiments of the system include that refining the estimated position of the processing system to generate the refined position of the processing system further includes performing tracking stabilization using the second data.

In addition to one or more of the features described herein, or as an alternative, further embodiments of the system include that the sensor is a camera.

In addition to one or more of the features described herein, or as an alternative, further embodiments of the system include that the sensor is an inertial measurement unit.

In addition to one or more of the features described herein, or as an alternative, further embodiments of the system include that the sensor is a compass.

In addition to one or more of the features described herein, or as an alternative, further embodiments of the system include that the operations further include performing tracking stabilization using the estimated position of the processing system and the second data.

In addition to one or more of the features described herein, or as an alternative, further embodiments of the system include that the operations further include performing tracking stabilization using the refined position of the processing system and the second data.

In another exemplary embodiment, a method is provided. The method includes detecting, by a processing system, at least one feature point within a frame of a video stream from a camera of the processing system, the video stream capturing an environment that includes a three-dimensional (3D) coordinate measurement device. The method further includes identifying, by the processing system, a type of the 3D coordinate measurement device. The method further includes determining, by the processing system, a relative position of the 3D coordinate measurement device relative to the processing system based at least in part on the at least one feature point. The method further includes displaying, on a display of the processing system, an augmented reality representation of a point cloud of the environment, wherein the augmented reality view includes a representation of the 3D coordinate measurement device based at least in part on the type of the 3D coordinate measurement device and based at least in part on the relative position of the 3D coordinate measurement device relative to the processing system.

In addition to one or more of the features described herein, or as an alternative, further embodiments of the method include that identifying the type of the 3D coordinate measurement device is based at least in part on a unique identifier associated with the 3D coordinate measurement device

In addition to one or more of the features described herein, or as an alternative, further embodiments of the method include that the unique identifier is a quick response (QR) code.

In addition to one or more of the features described herein, or as an alternative, further embodiments of the method include that identifying the type of the 3D coordinate measurement device includes scanning, using the camera of the processing system, the unique identifier associated with the 3D coordinate measurement device.

In addition to one or more of the features described herein, or as an alternative, further embodiments of the method include that identifying the type of the 3D coordinate measurement device includes determining, by the processing system, the type of the 3D coordinate measurement device based at least in part on the unique identifier.

In addition to one or more of the features described herein, or as an alternative, further embodiments of the method include that identifying the type of the 3D coordinate measurement device includes receiving, from a database, information about the 3D coordinate measurement device, including the type of the 3D coordinate measurement device, using the unique identifier.

In addition to one or more of the features described herein, or as an alternative, further embodiments of the method include that determining the relative position of the 3D coordinate measurement device relative to the processing system includes using a simultaneous localization and mapping algorithm to determine the relative position of the processing system relative to the 3D coordinate measurement device.

In addition to one or more of the features described herein, or as an alternative, further embodiments of the method include that determining the relative position of the 3D coordinate measurement device relative to the processing system further includes: performing feature mapping using data collected by a sensor associated with the processing system and 3D data collected by the 3D coordinate measurement device; and refining the relative position of the processing system relative to the 3D coordinate measurement device based at least in part on the feature mapping.

In addition to one or more of the features described herein, or as an alternative, further embodiments of the method include that the representation of the 3D coordinate measurement device is a computer aided design (CAD) model.

In addition to one or more of the features described herein, or as an alternative, further embodiments of the method include that the unique identifier is displayed on a display of the 3D coordinate measurement device.

In addition to one or more of the features described herein, or as an alternative, further embodiments of the method include that the unique identifier is an electronic unique identifier.

In addition to one or more of the features described herein, or as an alternative, further embodiments of the method include that the 3D coordinate measurement device is a laser scanner.

In addition to one or more of the features described herein, or as an alternative, further embodiments of the method include that the displaying further includes displaying a visual analysis result along with the point cloud, wherein the visual analysis result includes at least one of a color, a symbol, or text.

In another exemplary embodiment, a system is provided. The system includes a display, a memory having computer readable instructions, and a processing device for executing the computer readable instructions. The computer readable instructions control the processing device to perform operations. The operations include detecting at least one feature point within a frame of a video stream from a camera of the processing system, the video stream capturing an environment that includes a three-dimensional (3D) coordinate measurement device. The operations further include identifying a type of the 3D coordinate measurement device based at least in part on a unique identifier associated with the 3D coordinate measurement device. The operations further include determining a relative position of the 3D coordinate measurement device relative to the processing system based at least in part on the at least one feature point. The operations further include displaying, on the display, an augmented reality representation of a point cloud of the environment, wherein the augmented reality view includes a representation of the 3D coordinate measurement device based at least in part on the type of the 3D coordinate measurement device and based at least in part on the relative position of the 3D coordinate measurement device relative to the processing system.

In addition to one or more of the features described herein, or as an alternative, further embodiments of the system include that the unique identifier is a quick response (QR) code.

In addition to one or more of the features described herein, or as an alternative, further embodiments of the system include that identifying the type of 3D coordinate measurement device includes scanning, using the camera of the processing system, the unique identifier associated with the 3D coordinate measurement device.

In addition to one or more of the features described herein, or as an alternative, further embodiments of the system include that identifying the type of 3D coordinate measurement device includes determining, by the processing system, the type of the 3D coordinate measurement device based at least in part on the unique identifier.

In addition to one or more of the features described herein, or as an alternative, further embodiments of the system include that identifying the type of 3D coordinate measurement device includes receiving, from a database, information about the 3D coordinate measurement device, including the type of the 3D coordinate measurement device, using the unique identifier.

In addition to one or more of the features described herein, or as an alternative, further embodiments of the system include that determining the relative position of the 3D coordinate measurement device relative to the processing system includes using a simultaneous localization and mapping algorithm to determine the relative position of the processing system relative to the 3D coordinate measurement device.

In addition to one or more of the features described herein, or as an alternative, further embodiments of the system include that determining the relative position of the 3D coordinate measurement device relative to the processing system further includes: performing feature mapping using data collected by a sensor associated with the processing system and 3D data collected by the 3D coordinate measurement device; and refining the relative position of the processing system relative to the 3D coordinate measurement device based at least in part on the feature mapping.

In addition to one or more of the features described herein, or as an alternative, further embodiments of the system include that the representation of the 3D coordinate measurement device is a computer aided design (CAD) model.

In addition to one or more of the features described herein, or as an alternative, further embodiments of the system include that the unique identifier is displayed on a display of the 3D coordinate measurement device.

In addition to one or more of the features described herein, or as an alternative, further embodiments of the system include that the unique identifier is an electronic unique identifier.

In addition to one or more of the features described herein, or as an alternative, further embodiments of the system include that the 3D coordinate measurement device is a laser scanner.

In another exemplary embodiment, a method is provided. The method includes detecting, by a processing system, at least one feature point within a frame of a video stream from a camera of the processing system, the video stream capturing an environment that includes a three-dimensional (3D) coordinate measurement device. The method further includes determining, by the processing system, a relative position of the 3D coordinate measurement device relative to the processing system based at least in part on the at least one feature point. The method further includes displaying, on a display of the processing system, an augmented reality representation of a point cloud of the environment based at least in part on the relative position of the 3D coordinate measurement device relative to the processing system.

In another exemplary embodiment, a method is provided. The method includes receiving, at a processing system, first three-dimensional (3D) data of an environment, the first 3D data being captured by a 3D coordinate measurement device during a first scan at a first location relative to the environment. The method further includes displaying, on a display of the processing system, a first augmented reality representation of a first point cloud of the environment, the first point cloud being based at least in part on the first 3D data. The method further includes receiving, at the processing system, second 3D data of the environment, the second 3D data being captured by the 3D coordinate measurement device during a second scan at a second location relative to the environment. The method further includes displaying, on a display of the processing system, a second augmented reality representation of the first point cloud of the environment and a second point cloud of the environment, the second point cloud being based at least in part on the second 3D data.

In addition to one or more of the features described herein, or as an alternative, further embodiments of the method include that the first augmented reality view includes a representation of the 3D coordinate measurement device.

In addition to one or more of the features described herein, or as an alternative, further embodiments of the method include that the representation of the 3D coordinate measurement device is based at least in part on a type of the 3D coordinate measurement device and based at least in part on a relative position of the 3D coordinate measurement device relative to the processing system.

In addition to one or more of the features described herein, or as an alternative, further embodiments of the method include selecting, based at least in part on the first augmented reality representation of a first point cloud of the environment, the second location relative to the environment to perform the second scan of the environment.

In addition to one or more of the features described herein, or as an alternative, further embodiments of the method include that the selecting the second location relative to the environment to perform the second scan of the environment is based at least in part on an input from a user.

In addition to one or more of the features described herein, or as an alternative, further embodiments of the method include that the selecting the second location relative to the environment to perform the second scan of the environment is based at least in part on a density of the first point cloud.

In addition to one or more of the features described herein, or as an alternative, further embodiments of the method include associating an annotation with at least a portion of the first point cloud or the second point cloud.

In addition to one or more of the features described herein, or as an alternative, further embodiments of the method include: generating an estimated topology of the environment using the processing system; comparing the first point cloud to the estimated topology; determining whether a deviation exists between the first point cloud and the estimated topology; and responsive to determining that the deviation satisfies a threshold amount, generating an indication of the deviation within the first augmented reality representation.

In addition to one or more of the features described herein, or as an alternative, further embodiments of the method include that the deviation exists when a distance between a feature extracted from part of the first point cloud differs by the threshold amount from an associated feature of the estimated topology.

In addition to one or more of the features described herein, or as an alternative, further embodiments of the method include that third 3D data are captured by a second 3D coordinate measurement device.

In addition to one or more of the features described herein, or as an alternative, further embodiments of the method include that displaying the first augmented reality representation of the first point cloud of the environment includes overlaying, on the display, the first point cloud onto a video stream captured by a camera of the processing system.

In addition to one or more of the features described herein, or as an alternative, further embodiments of the method include that displaying the second augmented reality representation of the second point cloud of the environment includes overlaying, on the display, the second point cloud onto a video stream captured by a camera of the processing system.

In addition to one or more of the features described herein, or as an alternative, further embodiments of the method include that the 3D coordinate measurement device is a laser scanner.

In another exemplary embodiment, a system is provided. The system includes a three-dimensional (3D) coordinate measurement device to capture 3D data about an environment and a processing system. The processing system includes a display, a memory having computer readable instructions, and a processing device for executing the computer readable instructions. The computer readable instructions control the processing device to perform operations. The operations include receiving, at the processing system, first 3D data of the environment, the first 3D data being captured by the 3D coordinate measurement device during a first scan at a first location relative to the environment. The operations further include displaying, on the display, a first augmented reality representation of a first point cloud of the environment, the first point cloud being based at least in part on the first 3D data. The operations further include selecting, based at least in part on the first augmented reality representation of a first point cloud of the environment, a second location relative to the environment to perform a second scan of the environment. The operations further include receiving, at the processing system, second 3D data of the environment, the second 3D data being captured by the 3D coordinate measurement device during the second scan at the second location relative to the environment. The operations further include displaying, on a display of the processing system, a second augmented reality representation of the first point cloud of the environment and a second point cloud of the environment, the second point cloud being based at least in part on the second 3D data.

In addition to one or more of the features described herein, or as an alternative, further embodiments of the system include that the selecting the second location relative to the environment to perform the second scan of the environment is based at least in part on an input from a user.

In addition to one or more of the features described herein, or as an alternative, further embodiments of the system include that the selecting the second location relative to the environment to perform the second scan of the environment is based at least in part on a density of the first point cloud.

In addition to one or more of the features described herein, or as an alternative, further embodiments of the system include that the instructions further include associating an annotation with at least a portion of the first point cloud or the second point cloud.

In addition to one or more of the features described herein, or as an alternative, further embodiments of the system include that the instructions further include: generating an estimated topology of the environment using the processing system; comparing the first point cloud to the estimated topology; determining whether a deviation exists between the first point cloud differs and the estimated topology; and responsive to determining that the deviation satisfies a threshold amount, generating an indication of the deviation within the first augmented reality representation.

In addition to one or more of the features described herein, or as an alternative, further embodiments of the system include that the deviation exists when a distance between the a first point of the first point cloud differs by the threshold amount from an associated first point of the estimated topology.

In addition to one or more of the features described herein, or as an alternative, further embodiments of the system include that generating the estimated topology is performed using simultaneous localization and mapping.

In addition to one or more of the features described herein, or as an alternative, further embodiments of the system include that the 3D coordinate measurement device is a laser scanner.

In another exemplary embodiment, a method is provided. The method includes generating a first point cloud of an environment based at least in part on three-dimensional (3D) data captured during a first scan. The method further includes generating a second point cloud of the environment based at least in part on 3D data captured during a second scan. The method further includes comparing, by a processing system, the first point cloud and the second point cloud to identify a difference between the first point cloud and the second point cloud. The method further includes displaying, on a display of the processing system, an augmented reality representation of at least the difference between the first point cloud and the second point cloud.

In addition to one or more of the features described herein, or as an alternative, further embodiments of the method include that the first 3D data are captured by a 3D coordinate measurement device.

In addition to one or more of the features described herein, or as an alternative, further embodiments of the method include that the 3D coordinate measurement device is a laser scanner.

In addition to one or more of the features described herein, or as an alternative, further embodiments of the method include that the second 3D data are captured by a light detection and ranging sensor of the processing system.

In addition to one or more of the features described herein, or as an alternative, further embodiments of the method include that displaying the augmented reality representation of at least the difference between the first point cloud and the second point cloud further includes displaying the first point cloud and the second point cloud.

While the disclosure is provided in detail in connection with only a limited number of embodiments, it should be readily understood that the disclosure is not limited to such disclosed embodiments. Rather, the disclosure is modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) include only some of the described exemplary aspects. Accordingly, the disclosure is not to be seen as limited by the foregoing description, but is only limited by the scope of the appended claims.

What is claimed is:

1. A method comprising:
collecting, by a processing system, first data comprising first surface points within an environment by a sensor of the processing system;
determining, by the processing system, an estimated position of the processing system within the environment by analyzing the first data using a simultaneous localization and mapping algorithm;
identifying, by the processing system, a first set of surface features within the environment from the first data;
collecting, by a three-dimensional (3D) coordinate measuring device, second data comprising second surface points within the environment, the 3D coordinate measuring device separate from the sensor and the processing system;
identifying, by the processing system, a second set of surface features within the environment from the second data, the second data received by the processing system from the three-dimensional (3D) coordinate measuring device;
matching, by the processing system, the first set of surface features to the second set of surface features;
refining, by the processing system, the estimated position of the processing system to generate a refined position of the processing system based on the matching; and
displaying, by the processing system, on a display of the processing system, a representation of the second data based at least in part on the refined position.

2. The method of claim 1, wherein the 3D coordinate measurement device comprises one of: a laser scanner, a triangulation scanner and a structured light scanner.

3. The method of claim 2, wherein the second data includes 3D measurement data comprising measured distance information from the 3D coordinate measurement device to at least one of the second surface points.

4. The method of claim 1, wherein the sensor is at least one of a camera, a video camera, a panoramic camera, an inertial measurement unit, a light detection and ranging (LIDAR) sensor or a compass; and the representation is an augmented reality representation.

5. The method of claim 1, wherein the sensor is a camera and the first data comprises video data.

6. The method of claim 1, wherein refining the estimated position of the processing system comprises performing tracking stabilization using the second data by determining a global coordinate system for measuring the environment based on at least one of the estimated position and the refined position.

7. A method comprising:
measuring first three-dimensional (3D) data with a 3D coordinate measurement device during a first scan initiated by a processing system at a first location within an environment;
generating, by the processing system, a first point cloud representing first surface points in the environment based at least in part on the first 3D data;
measuring second 3D data by the 3D coordinate measurement device during a second scan at a second location within the environment;
generating, by the processing system, a second point cloud representing second surface points in the environment based at least in part on the second 3D data;
capturing video data of the second surface points in the environment using a camera during at least one of the first scan or the second scan; and
displaying, on a display of the processing system, an augmented reality representation of the environment including at least a portion of each of the first point cloud, the second point cloud and the video data.

8. The method of claim 7, the augmented reality representation further including a representation of the 3D coordinate measurement device within the environment.

9. The method of claim 8, wherein the representation of the 3D coordinate measurement device is based on at least one of: (i) a type of the 3D coordinate measurement device determined from a unique identifier associated therewith, or (ii) a relative position of the 3D coordinate measurement device with respect to the processing system.

10. The method of claim 7, further comprising: selecting the second location based at least in part on a density of the first point cloud of the environment.

11. The method of claim 7, wherein the processing system and the camera are separate from the 3D coordinate measurement device.

12. The method of claim 7, further comprising associating an annotation input by a user with at least a portion of at least one of the first point cloud or the second point cloud.

13. The method of claim 7, further comprising:
generating an estimated topology of the environment by capturing images of the environment using the camera and using a simultaneous mapping and localization algorithm on the images executed by the processing system;
comparing the first point cloud to the estimated topology;
determining whether a deviation exists between the first point cloud and the estimated topology; and
responsive to determining that the deviation satisfies a threshold amount, generating an indication of the deviation within the augmented reality representation.

14. The method of claim 13, wherein the deviation exists when a distance between a feature extracted from part of the first point cloud differs by the threshold amount from an associated feature of the estimated topology.

15. The method of claim 7, wherein displaying the augmented reality representation further comprises overlaying, on the display, at least a portion of each of the first point cloud, the second point cloud and the video data.

16. A method performed by a processing system, the method comprising:
generating a first point cloud of an environment based at least in part on first three-dimensional (3D) data captured during a first scan;
generating a second point cloud of the environment based at least in part on second 3D data captured during a second scan;
comparing the first point cloud and the second point cloud to identify a difference between the first point cloud and the second point cloud; and
displaying, on a display, an augmented reality representation including at least an identification of the difference between the first point cloud and the second point cloud.

17. The method of claim 16, further comprising capturing the first 3D data by a 3D coordinate measurement device in communication with the processing system.

18. The method of claim 17, the 3D coordinate measurement device is separate from the processing system and comprises at least one of a laser scanner, a triangulation scanner, or a structured light scanner.

19. The method of claim 17, further comprising capturing the second 3D data by a light detection and ranging sensor in communication with the processing system.

20. The method of claim 16, further comprising:
capturing video data of the environment using a camera of the processing system during at least one of the first scan or the second scan; and
wherein the displaying further comprises displaying, on a display of the processing system, the augmented reality representation that includes an overlay of the video data showing the identification of the difference between the first point cloud and the second point cloud.
